(19) United States
(12) Patent Application Publication
(10) Pub. No.: US 2012/0147173 A1
(43) Pub. Date: Jun. 14, 2012

(54) HAND-CARRYABLE PUSHROD-BASED CAMERA SYSTEM

(76) Inventor: Christopher J. Lynch, Landing, NJ (US)

(21) Appl. No.: 13/314,713

(22) Filed: Dec. 8, 2011

Related U.S. Application Data
(60) Provisional application No. 61/421,933, filed on Dec. 10, 2010.

(51) Int. Cl. H04N 7/18

(52) U.S. Cl. 348/84; 348/E07.087

(57) ABSTRACT

A hand-carryable pushrod-based camera system includes a storage cage rotatably supported on a manually-graspable handle, a semi-rigid pushrod having a distal end, at least a portion of the pushrod being coiled within the storage cage, an image monitor supported on the handle, a camera comprising an illumination system, the camera being supported on the distal end of the pushrod and being capable of capturing at least one of video and still images; and a cable extending along and supported by the pushrod, the cable comprising a first conductor carrying a power signal to the camera and a second conductor carrying an image signal from the camera to the image monitor. The cable may include no more than four conductors in a low-voltage system. The camera system may include a port permitting physical detachment of the image monitor, and a controller board wirelessly communicating image signals to the image monitor.

### CROSS-REFERENCE TO RELATED APPLICATION

This application claims the benefit of priority under 35 USC 119(e) of U.S. Provisional Patent Application No. 61/421/933, filed Dec. 10, 2010, the entire disclosure of which is hereby incorporated herein by reference.

### FIELD OF THE INVENTION

The present invention relates generally to camera-based inspection systems for inspecting pipelines, conduits and the like, and more particularly to a portable pushrod-based camera system that may be hand carried and used in locations not readily accessible to ground-based inspection systems.

### BACKGROUND

Various camera-based inspection systems are well-known in the art for visually inspecting the interior surface of pipelines, conduits, pipes, ducts, heat exchangers and other similar structures (collectively, “pipelines”) commonly used for transporting storm or sanitary sewage, air, liquids, gases, slurries and the like. Such camera-based inspection systems generally include a camera (including a lighting system), a base station that includes a video monitor and/or video recording equipment, and a cable interconnecting the camera and the base station, for carrying electrical power and image signals to/from the camera.

A certain class of such camera-based inspection systems are pushrod-based in that the camera is mounted at the end of a semi-rigid pushrod. The pushrod unsheathes the conductors of a multi-conductor cable, and further is sufficiently rigid to permit the camera to be advanced, withdrawn, or otherwise manipulated in the pipeline, etc. by manual advancement, retraction or other manipulation of the pushrod.

Typical pushrod-based inspection applications require at least 100 linear feet of pushrod to allow for adequate inspection system capability. Further, typical pushrod-based inspection systems include a 12-24 volt DC power supply and a 12-volt or 24-volt camera. To allow for voltage drop issues over the pushrod/cable length, an exemplary pushrod-based inspection system employs a 10-conductor cable, in which each conductor is 24-16 AWG, and in which two of the conductors are used for grounding purposes, two are used for camera power conduction purposes, four are used for illumination/lighting power conduction purposes, and two are used for image signal propagation purposes. By way of example, such a 10-conductor cable is suitable for a system including incandescent based illumination, in which 4 conducts are used for illumination/lighting power conduction purposes. Alternatively, for example, an 8-conductor cable may be used in a system including low-power LED-lighting based illumination. In such an embodiment, each conductor is again 24-16 AWG, and two of the conductors are used for grounding purposes, two are used for camera power conduction purposes, two are used for illumination/lighting power conduction purposes, and two are used for image signal propagation purposes. In either case, the conductors are supported by a fiberglass or other stiffening member, e.g., by winding the conductors around the stiffening member. As a result, the conductor bundle/cable is fairly thick in cross-section, and the pushrod required to ensheath the cable is similarly thick in cross-section. The significant weight of the 12 volt camera further contributes to the need for a relatively thick pushrod. The combined dimensions and rigidity requirements for the cable and pushrod result in a pushrod having a significant weight per linear foot, which for a standard length of 100 feet or more is sufficiently heavy to preclude hand carrying of the inspection system, especially when coupled with a image monitor and other components of the system. Many suitable commercially available 12-24 volt camera-based systems have a weight ranging from approximately 40 pounds to approximately 80 pounds. Accordingly, as a practical matter, the 12-24 volt systems are ground-based, in that the base unit, which supports the cable/pushrod not yet extended for inspection purposes and the image monitor, remains on the ground during normal use, e.g., on a hand truck, dolley or cart having ground-engaging wheels or the like. An example of such a ground-based inspection system is the p571 or p330 manufactured and/or sold by Pearpoint, Inc. of Thousand Palms, Calif.

Such ground-based inspection systems have been suitable for traditional inspection applications, which have included predominantly ground-based inspection areas, such as below-ground sewer/stormwater piping and conduits. However, it has become desirable to inspect a variety of above-ground applications, such as overhead piping systems, air handling ducts, and electrical or other conduits. Such above-ground applications often require an operator to climb a ladder, scaffold, etc. before feeding the camera/pushrod into the area to be inspected. Conventional ground-based inspection systems have been found unsuitable for this purpose because of their weight and because their image monitors are included in the base unit, which remains on the ground. Thus, an operator cannot simultaneously monitor the video feed while advancing the pushrod/camera, but rather must climb up and down the ladder, scaffold, etc. between camera advancement and image monitoring operations, which is quite cumbersome and unsatisfactory.

Therefore, a portable (hand-carryable) self-contained, pushrod-based camera system is needed that permits monitoring of video during advancement of the cable/camera from above-ground inspection locations. The present invention fulfills this need among others.

### SUMMARY

The present invention provides a portable pushrod-based camera system for inspecting a pipeline that is specially-designed to be sufficiently lightweight and compact that it may be carried by a human operator to a pipeline access point positioned at an elevated position above the ground. More specifically, the present invention provides a hand-carryable camera system for inspecting a pipeline that includes a storage cage rotatably supported on a manually-graspable handle, a semi-rigid pushrod having a distal end, at least a portion of the pushrod being coiled within the storage cage, an image monitor supported on the handle, a camera comprising an illumination system, the camera being supported on the distal end of the pushrod and being capable of capturing at least one of video and still images; and a cable extending along and supported by the pushrod, the cable comprising a first conductor carrying a power signal to the camera and a second conductor carrying an image signal from the camera to the image monitor.

In one embodiment, the hand-carryable camera system is realized at least in part by use of a low-voltage configuration involving one or more low-voltage power supplies, a low voltage camera, and a low-voltage image monitor. In part, the use of the low-voltage configuration allows for use of relative few (no more than 4) conductors of small gauge, and thus relatively light weight.

Optionally, the camera system includes a port permitting physical detachment and re-attachment of an image monitor, and the camera system includes a controller board configured to communicate image signals to the image monitor via wireless transmission. In one embodiment, the controller board is configured to sense detachment of the image monitor and switch from wired transmission of the image signal to wireless transmission of the image signal in response to detachment of the image monitor from the port.

Also provided is a method for inspecting a pipeline having an access point elevated above the ground. The method includes providing a hand-carryable pushrod-based camera system for inspecting a pipeline, and an operator carrying the hand-carryable pushrod-based camera system to the access point. Further, while the operator is positioned above the ground and adjacent the access point, the operator: grasps the handle of the hand-carryable pushrod-based camera system with the operator's first hand; advances the pushrod and the camera into the pipeline via the access point with the operator's second hand; and visually observes images displayed on the image monitor of the system.

### BRIEF DESCRIPTION OF DRAWINGS

The present invention will now be described by way of example with reference to the following drawings in which:

FIG. 1 is a perspective view of a hand-carryable pushrod-based camera system in accordance with an exemplary embodiment of the present invention;

FIG. 2 is a front elevational view of the system of FIG. 1, showing a human hand grasping its handle and carrying the system;

FIG. 3 is a rear perspective view of the system of FIG. 1;

FIG. 4 is a rear perspective view of the system of FIG. 1, with the handle, cable and camera removed for illustrative clarity;

FIG. 5 is a rear perspective view of the system of FIG. 1 showing an internal battery compartment, with the handle, cable and camera removed for illustrative clarity;

FIG. 6 is a rear elevational view of the system of FIG. 1, showing an internal controller board, with the handle, cable and camera removed for illustrative clarity;

FIG. 7 is a partial right side view of the system of FIG. 1, showing a rotary lighting control switch and monitor control buttons;

FIG. 8 is a partial left side view of the system of FIG. 1, showing a DC power port and monitor control buttons;

FIG. 9 is a partial perspective view of the system of FIG. 1, showing the image monitor physically detached from a port on the housing;

FIG. 10 is a perspective view of a camera head assembly of the system of FIG. 1; and

FIG. 11 is a schematic view of the system of FIG. 1.

### DETAILED DESCRIPTION

Generally, the present invention provides a pushrod-based camera system for inspecting a pipeline that is specially-designed to be sufficiently lightweight (e.g., less than five (5) pounds in total combined weight) and compact that it may be carried by a human operator to a pipeline access point positioned at an elevated position above the ground. Further, the hand-carryable system is sufficiently lightweight and compact that it may be used while the operator is positioned above the ground (e.g., on a ladder or scaffold) and adjacent the access point by grasping the system's handle with the operator's first hand, and advancing the system's pushrod and camera into the pipeline with the operator's second hand, while the operator visually observes images displayed on the hand held system's image monitor. Thus, the entire inspection operation may be conducted by a single operator from an inspection point elevated above the ground, or within a confined space, such as a steam drum.

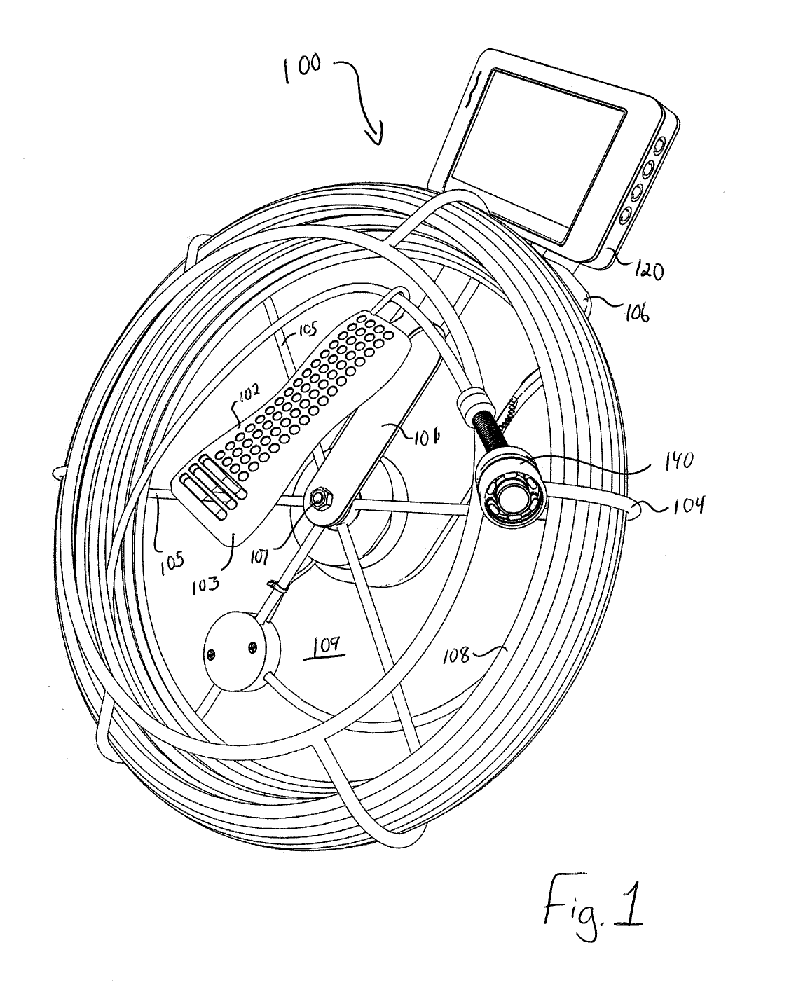

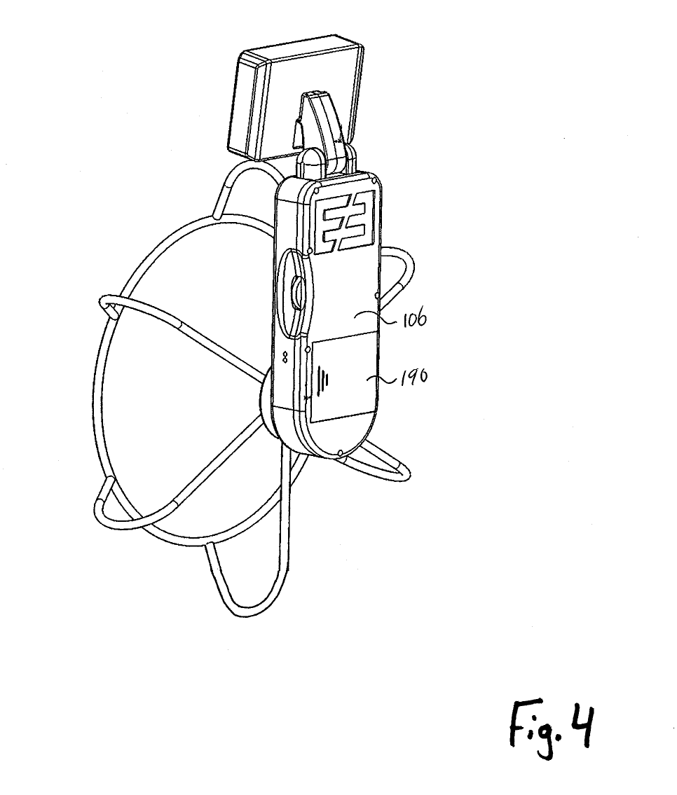

The present invention is discussed below in greater detail with reference to the exemplary embodiment show in FIGS. 1-10. Referring now to FIGS. 1-3, an exemplary hand-carryable pushrod-based camera system 100 is shown. As best shown in FIG. 1, the system 100 includes a manually-graspable handle 102, a storage cage 104, and a housing 106. The exemplary handle 102 includes a shaped metal core 101 covered by an outer rubber grip 103. The handle 102 and housing 106 are fixedly interconnected (e.g., by a bolt) to prohibit relative motion/rotation therebetween, such that manually grasping and retaining the handle in a fixed position/orientation causes the housing 106 to be retained in a corresponding fixed position/orientation.

The storage cage 104 is rotatably supported on the handle 102, and thus is rotatable relative to a central axis, e.g., about the handle. The storage cage may have any suitable form. In this example, the storage cage 104 generally resembles a reel formed by interconnected metal spokes 105 extending from a central hub 107. Collectively, the spokes 105 define an internal circular region 109 bounded by the spokes 103.

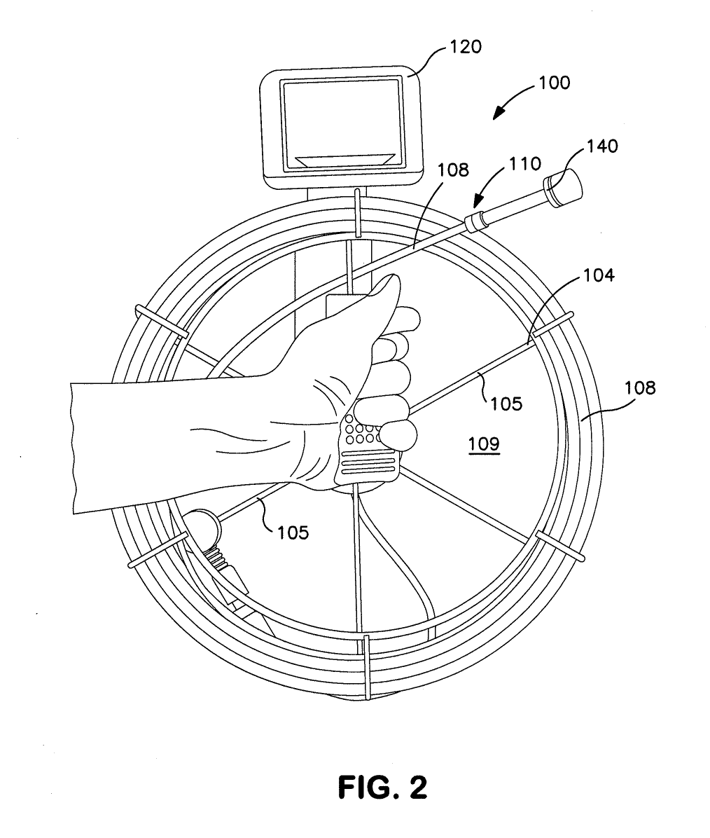

The system 100 further includes a semi-rigid pushrod 108 having a distal end 110 (see FIG. 2). The pushrod 108 may be constructed of any suitable material and may have any suitable dimensions, provided that the pushrod is capable of supporting a camera (discussed below), withstanding forces exerted while advancing and retracting the camera in a pipeline, while also permit the pushrod to be coiled and stored within the circular region 109 defined by the spokes, as shown in FIGS. 1-3. Further, the pushrod 108 is hollow to house/ensheath a multi-conductor cable, as discussed below. By way of example, a suitable camera has been found to weigh approximately 2 ounces, and a suitable semi-rigid pushrod 108 constructed of fiberglass and having an outer diameter of approximately 0.1875 inches and a wall thickness of approximately 0.070 inches has been found suitable for this purpose. When not in use, all or substantially all of the pushrod 108 may be coiled within the internal region 109 of the storage cage 104, as shown in FIGS. 1-3. During use, at least a portion of the pushrod 108 typically remains coiled within the storage cage 104.

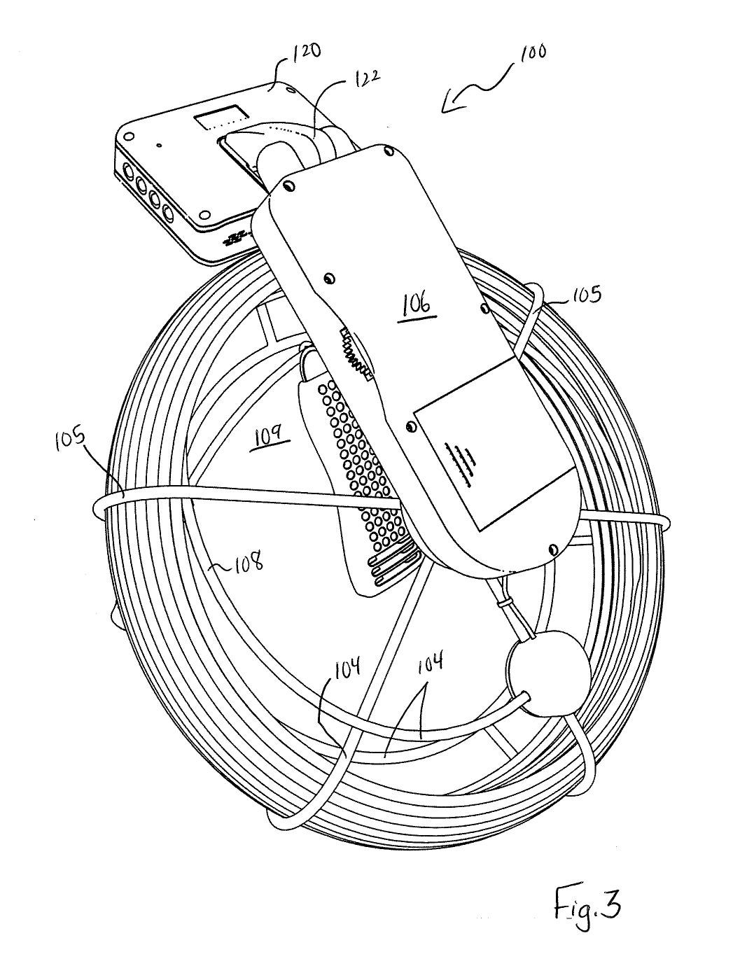

The system 100 further includes an image monitor 120 supported on the housing 106. Because the housing 106 is fixed in position relative to the handle 102, the image monitor 120 remains similarly fixed in that it does not rotate with the storage cage 104 but rather remains upright relative to the upright handle, in position for viewing. Optionally, the image monitor 120 is mounted on a movable mount 122 (see FIG. 3), such as a pivoting arm, so that the position of the image monitor may be adjusted relative to the housing 106 for ease of viewing.

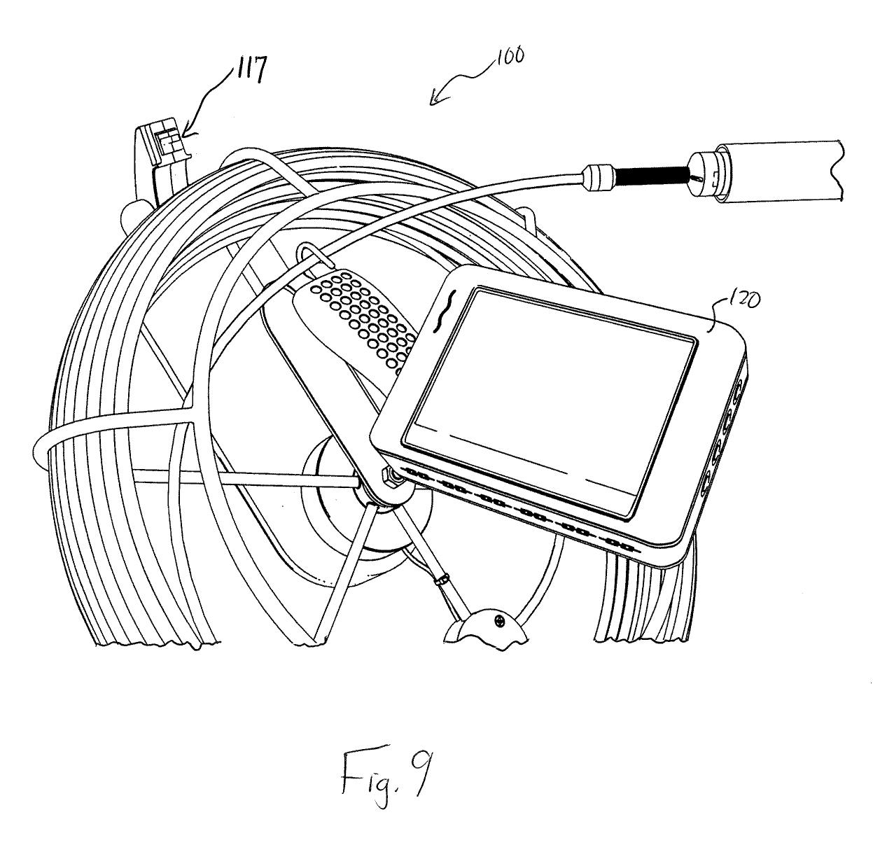

In a certain preferred embodiment, the housing 106 is configured with a port 117 permitting the image monitor to be readily detachable therefrom, as best shown in FIG. 9. In one such embodiment, the housing 106 is configured to supply power (see FIG. 9) to the image monitor 120, but the image monitor includes its own power source (e.g. internal AA batteries) permitting it to operate while disconnected from the housing 106, e.g., to display video images transmitted wirelessly from the housing 106 to the image monitor 120.

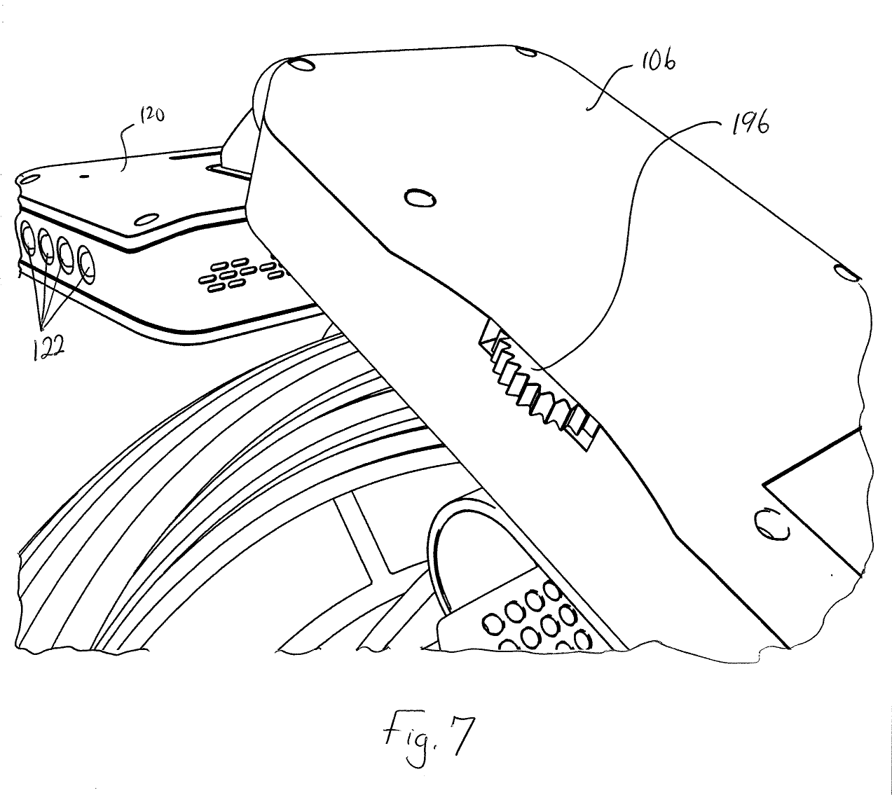

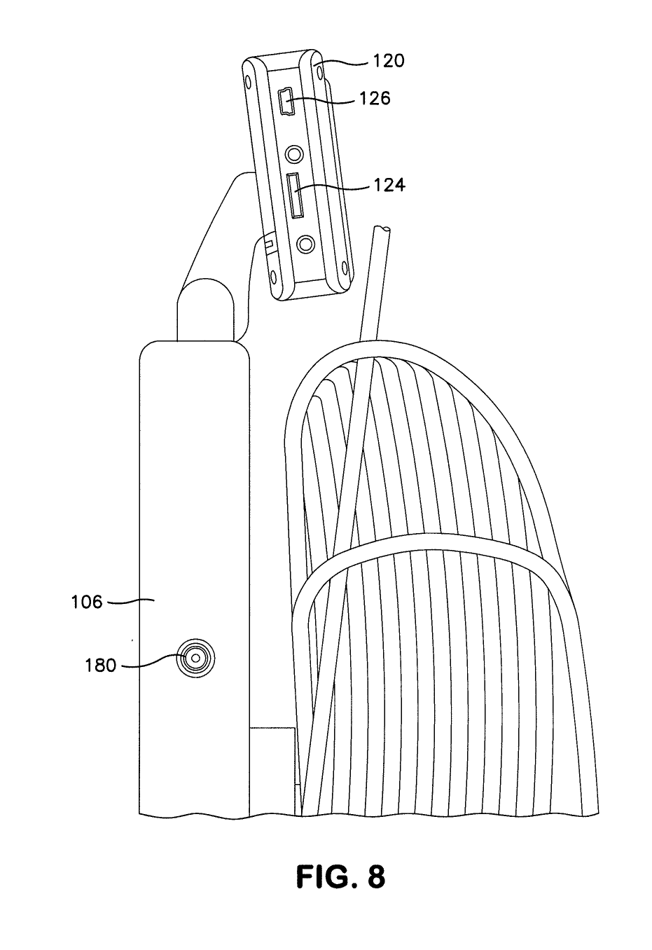

Any suitable image monitor 120 may be used for this purpose, such as the commercially-available HC1814 monitor manufactured and/or sold by Peerless Creations LLC of Landing, N.J. As is typical of many such image monitors, the image monitor 120 includes a data storage memory, video/image recording circuitry/hardware/software, and image manipulation/operation control buttons 122 (see FIG. 7). Further, the image monitor may be configured with an internal memory card port 124 (FIG. 8) to accommodate a memory card, such as a micro-SD card that may be used for storing images. Advantageously, such a memory card may be removed and inserted into another electronic device having a suitable card-receiving port, such as a cellular telephone/smartphone, to permit viewing of images recorded at the image monitor. Further, such a image monitor preferably includes a USB port 126 (FIG. 8) for transmitting stored images to a PC or other computing device via a USB connection.

Preferably, the image monitor 120 is configured to operate on a low voltage system (e.g., 5 VDC) and to communicate via wireless transmission, for reasons discussed below.

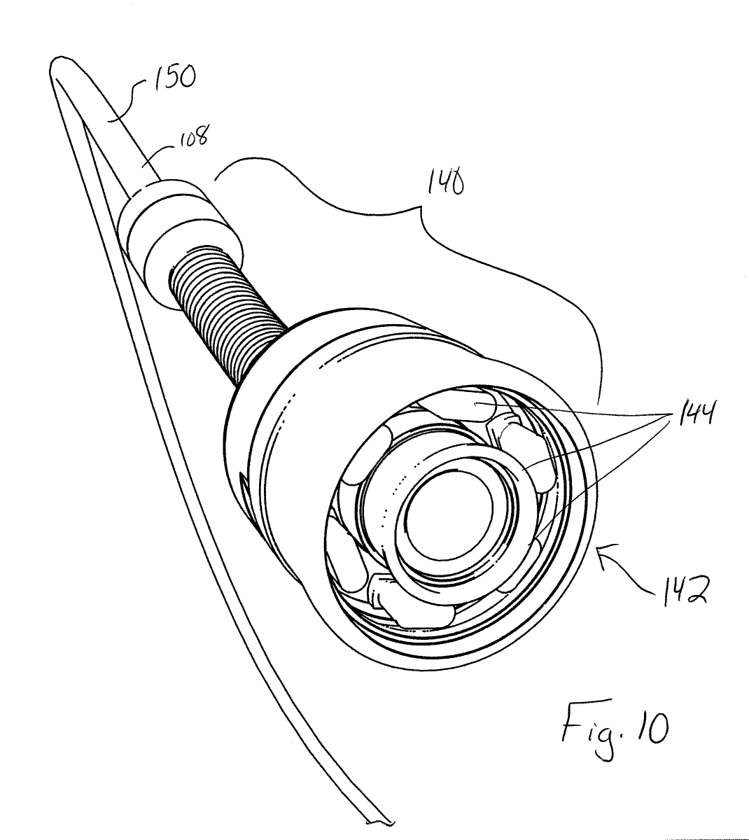

The system 100 further includes a camera 140 supported on the distal end 110 of the pushrod 108. The camera 140 is operatively connected to the image monitor as discussed below. The camera 140 includes an illumination system 142 (FIG. 10). Preferably the camera 140 is configured to operate on a low-voltage system, i.e., less than 12 volts DC, and preferably less than 5 volts DC, and the illumination units comprise a plurality of LEDs 144 (FIG. 10) that similarly operate on the low-voltage system. A exemplary suitable commercially-available 3 VDC camera weighs less than 1 pound, and more specifically, less than 4 ounces.

The system 100 further includes a cable 150 (FIG. 10) ensheathed within the pushrod 108. The cable 150 includes multiple conductors. For example, 30 AWG conductors have been found suitable for a 6-volt system. The conductors of the cable 150 carry power, ground and image signals.

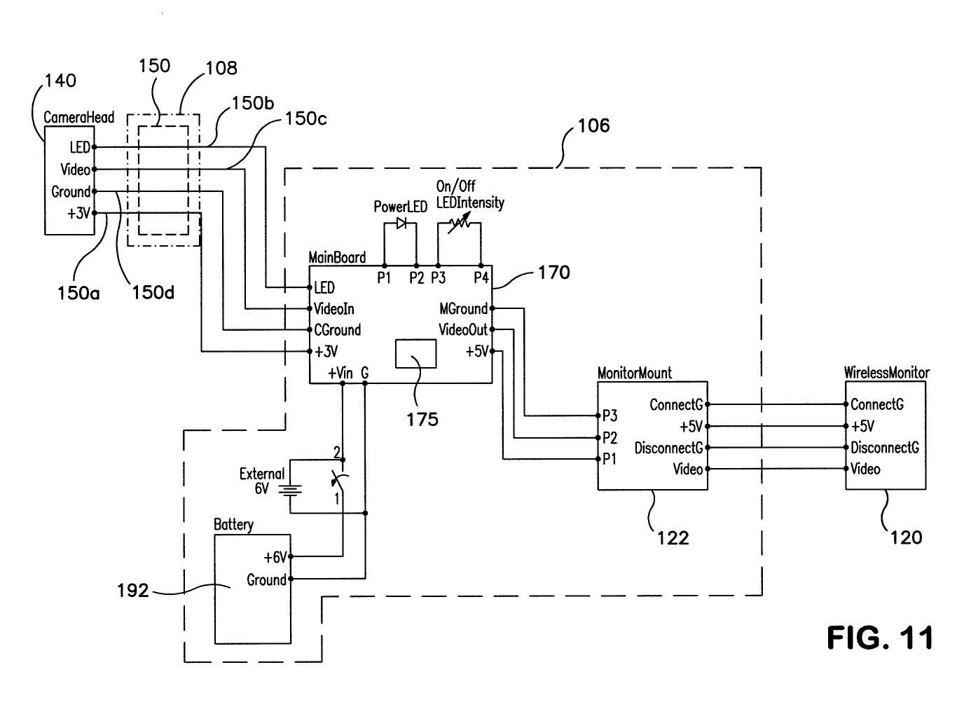

In a preferred embodiment the cable 150 includes no more than four conductors. In one such arrangement, a first of those conductors 150a carries a 3V DC power signal to a 3V DC camera 140, a second of those conductors 150b carries a 5V DC power signal to the illumination system 142 of the camera, a third of those conductors 150c carries a image signal from the camera 140, and a fourth of those conductors 150d provides a common ground connection, as shown in FIG. 11.

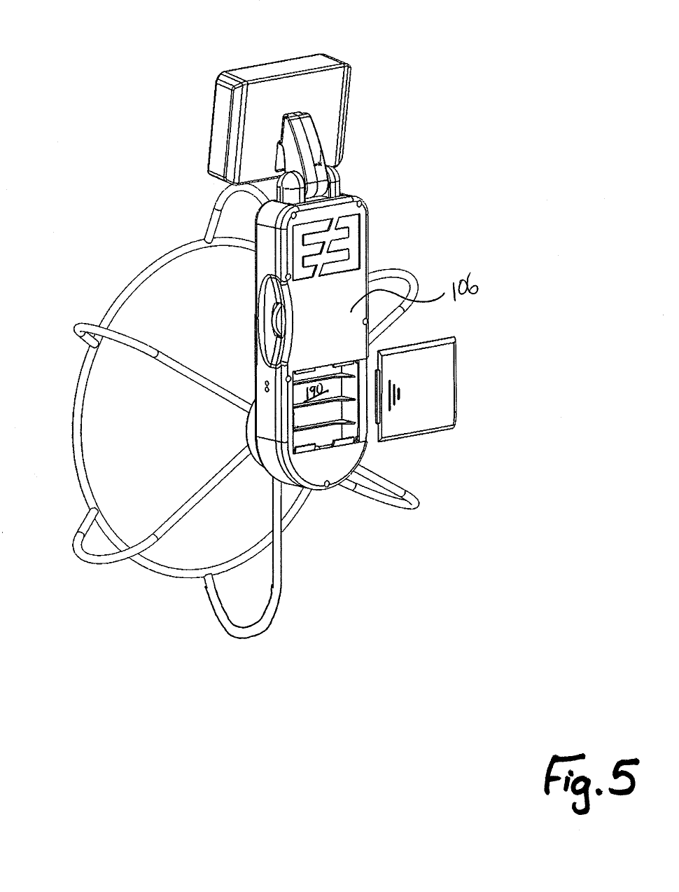

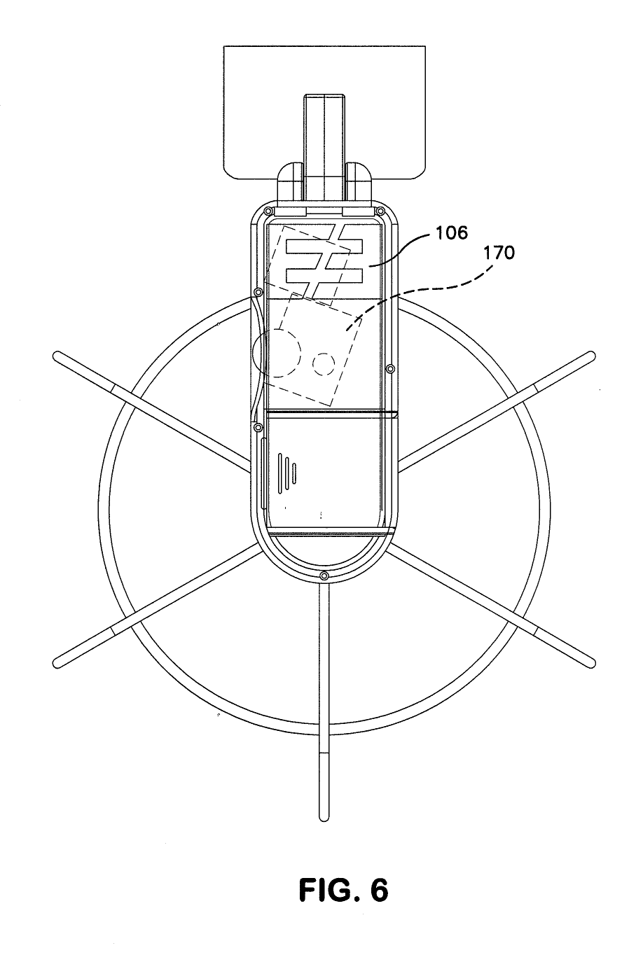

The system 100 further includes a controller board 170 housed within the housing 106, as best shown in FIG. 6. The controller board 170 is a specially-configured circuit board providing power distribution and image signal routing functions. With respect to power distribution, the controller board 170 is electrically coupled to a DC power port 180 (FIG. 8) (for use with an external AC/DC power adapter) and a battery compartment 190 (FIG. 5) housed within the housing 106. The controller board 170 is configured to distribute electrical power from a power source, such as 6V DC power source 192 (FIG. 11) (e.g., 4 AA batteries) housed within the battery compartment 190, and distribute power to the camera 140, and optionally to the monitor 120 (if the monitor does not have its own power source, or if it is desirable to use this power source while the monitor is attached to the housing 106). The controller board 170 is further configured to switch from battery power to external DC power in the event that an external power adapter is inserted into port 180. In this exemplary embodiment, the controller board 170 is configured to supply 3V DC to the camera 140, up to 5V DC (as varied by a potentiometer 194 (FIG. 10) operated by rotary switch 196 (FIG. 7) on housing 106, and optionally, 5 VDC to the monitor mount 122/image monitor 120.

With respect to its image signal routing function, the controller board 170 electrically couples the image signal received from the camera 140 to the image monitor 120, as shown in FIG. 10. In a preferred embodiment, the system 100 is configured to permit monitoring of image signals via the image monitor 120 in both a wired mode (in which the monitor 120 is physically attached to the monitor mount 122) and a wireless mode (in which the monitor 120 is physically detached from the monitor mount 122 as shown in FIG. 9). In such an embodiment, the controller board 170 is configured to determine whether the image monitor 120 is attached, i.e. electrically coupled, to the monitor mount 122. This is determined by the use of a 5V signal sent to the image monitor 120 via the monitor mount 122. When the image monitor 120 is connected to the monitor mount 122, the 5V DC signal flows through the image monitor 120, monitor mount 122, and back to the controller board 170 in a complete circuit. In this condition, it is confirmed that the image monitor 120 is physically attached to the monitor mount 122 and image signals are routed to the image monitor 120 via contacts in the monitor mount 122. However, if the image monitor 120 is physically detached from the monitor mount 122, an open circuit is created that prevents the 5V DC signal from flowing through the image monitor 120 and back to the controller board 170. The controller board 170 is configured to sense this open circuit and in response route the image signal received from the camera 140 to wireless transmission circuitry 175 (e.g., using 2.5 gigahertz wireless technology) included in the controller board 170. The physically detached image monitor 120, which includes complementary wireless transmission capability, receives and displays the image signal transmitted by the controller board's wireless transmission circuitry 175.

The system may be used to great advantage, as compared with ground-based inspection systems, to inspect a pipeline having an access point elevated above the ground. In use, a human operator may climb a ladder, scaffold, etc. while carrying the hand-carryable pushrod-based camera system to an above-the-ground access point. Then, while the operator is positioned above the ground and adjacent the access point, the operator can perform an inspection by manually grasping the handle 102 with one hand, manually advancing the pushrod 108 and supported camera 140 into the pipeline via the access point with the other hand, while at the same time visually observing images displayed on the image monitor 120, which may be attached to the housing 106, or may be detached therefrom. Notably, a single operator on a ladder or otherwise above the ground may thus hand-carry the entire system with him or her, e.g. up the ladder, and operate the system/camera while simultaneously viewing inspection images from a vantage point above the ground.

While the present invention has been particularly shown and described with reference to the preferred mode as illustrated in the drawing, it will be understood by one skilled in the art that various changes in detail may be effected therein without departing from the spirit and scope of the invention as defined by the claims.

What is claimed is:

1. A hand-carryable camera system for inspecting a pipeline, the system comprising:
a storage cage rotatably supported on a manually-graspable handle;
a semi-rigid pushrod having a distal end, at least a portion of said pushrod being coiled within said storage cage;
an image monitor supported on said handle;
a camera comprising an illumination system, said camera being supported on said distal end of said pushrod and being capable of capturing at least one of video and still images; and
a cable extending along and supported by said pushrod, said cable comprising a first conductor carrying a power signal to the camera and a second conductor carrying an image signal from said camera to said image monitor.

2. The camera system of claim 1, wherein said pushrod is hollow and ensheathes said cable.

3. The camera system of claim 1, further comprising a housing fixed to said handle, said image monitor being supported on said housing.

4. The camera system of claim 3, further comprising a controller board housed within said housing, said controller board coupling the image signal from said camera to said image monitor.

5. The camera system of claim 3, said housing further comprising a port supporting said image monitor on said handle in a manner permitting detachment therefrom.

6. The camera system of claim 5, said camera system further comprising a power supply supported on said housing, said port communicating a power signal from said power supply to said image monitor when said image monitor is supported on said port, said image monitor further comprising a separate power supply, said image monitor being configured to receive a respective power signal from said separate power supply when said image monitor is not supported on said port.

7. The camera system of claim 2, said camera system further comprising a low-voltage power supply supported on said housing, said image monitor being configured to operate on a low-voltage power signal.

8. The camera system of claim 7, wherein said low-voltage power supply provides a DC voltage signal of less than approximately 12 VDC.

9. The camera system of claim 8, wherein said low-voltage power supply provides a 6 VDC signal.

10. The camera system of claim 7, wherein said camera is configured to operate on a low-voltage system of less than approximately 5 VDC.

11. The camera system of claim 10, wherein said cable comprises no more than four conductors, a first of said conductors carrying a first low-voltage power signal to said camera, a second of said conductors carrying a second low-voltage power signal to said illumination system, a third of said conductors carrying an image signal from said camera, and a fourth of said conductors providing a common ground connection.

12. The camera system of claim 11, further comprising a 6 VDC low-voltage power supply, said first low-voltage power signal comprising a less than 5 VDC power signal, said second low-voltage power signal comprising a less than 5 VDC power signal.

13. The camera system of claim 4, the controller board being electrically coupled to a power source, the controller board being configured to transmit a first low-voltage power signal from said power source to said camera, a second low-voltage power signal to the illumination system, and a third low-voltage video signal to the image monitor.

14. The camera system of claim 13, further comprising an external power port and an internal battery power source, said controller board being configured to switch drawing power from said internal battery power source to said external power port if an external power adapter is inserted into said external power port.

15. The camera system of claim 13, further comprising a potentiometer operated by a rotary switch supported on the housing, said controller board being configured to supply a power signal having a voltage varying within a voltage range as a function of a position of the rotary switch.

16. The camera system of claim 4, the controller board being configured to electrically couple an image signal received from said camera to said image monitor via a wired connection when said image monitor is physically attached to a monitor mount, and via a wireless transmission connection when said image monitor is physically detached from said monitor mount.

17. The camera system of claim 16, wherein said controller board is configured to transmit a signal to said image monitor via said monitor mount, and from said image monitor back to said controller board via said monitor mount, the receipt of said signal at said controller board indicating that said image monitor is physically attached to said monitor mount, the non-receipt of said signal at said controller board indicating that said image monitor is physically detached from said monitor mount.

18. The camera system of claim 16, said controller board and said image monitor comprising complementary wireless transmission circuitry for communicating via said wireless transmission connection.

19. A hand-carryable pushrod-based camera system for inspecting a pipeline, the system comprising:
a manually-graspable handle;
a storage cage rotatably supported on said handle;
a semi-rigid pushrod having a distal end, at least a portion of said pushrod being coiled within said storage cage;
a housing fixed to said handle;
an image monitor supported on said housing;
a camera comprising an illumination system, said camera being supported on said distal end of said pushrod and being capable of capturing at least one of video and still images;
a cable ensheathed within said pushrod, said cable comprising a first conductor carrying a power signal to the camera and a second conductor carrying an image signal from said camera; and
a controller board housed within said housing, said controller board coupling the image signal from said camera to said image monitor.

20. A method for inspecting a pipeline having an access point elevated above the ground, the method comprising:
providing a hand-carryable pushrod-based camera system for inspecting a pipeline, the system comprising:
a manually-graspable handle;
a storage cage rotatably supported on said handle;
a semi-rigid pushrod having a distal end, at least a portion of said pushrod being coiled within said storage cage;
a housing fixed to said handle;
an image monitor supported on said housing;
a camera comprising an illumination system, said camera being supported on said distal end of said pushrod and being capable of capturing at least one of video and still images;
a cable extending along and supported by said pushrod, said cable comprising a first conductor carrying a power signal to the camera and a second conductor carrying an image signal from said camera;
a controller board housed within said housing, said controller board coupling the image signal from said camera to said image monitor;
an operator carrying said hand-carryable pushrod-based camera system to the access point;
while the operator is positioned above the ground and adjacent the access point, the operator:
grasping said handle of said hand-carryable pushrod-based camera system with the operator's first hand;
advancing said pushrod and said camera into the pipeline via the access point with the operator's second hand; and
visually observing images displayed on said image monitor of said system.
